(19) United States
(12) Patent Application Publication
(10) Pub. No.: US 2025/0370171 A1
(43) Pub. Date: Dec. 4, 2025

(54) MICROSCOPY METHOD AND SYSTEM

(71) Applicant: LA TROBE UNIVERSITY, Melbourne, Victoria (AU)

(72) Inventors: Brian Abbey, Melbourne (AU); Eugeniu Balaur, Melbourne (AU)

(21) Appl. No.: 19/239,786

(22) Filed: Jun. 16, 2025

Related U.S. Application Data
(63) Continuation of application No. 17/297,974, filed on May 27, 2021, now Pat. No. 12,332,463.

(30) Foreign Application Priority Data
Nov. 29, 2018 (AU) 2018904553

(51) Int. Cl. G02B 5/00; G01N 21/03; G01N 21/25; G01N 21/552; G01N 21/64; G02B 21/06; G02B 21/16; G02B 21/34

(52) U.S. Cl. CPC G02B 5/008; G01N 21/255; G01N 21/553; G01N 21/6458; G01N 21/648; G02B 21/06; G02B 21/16; G02B 21/34; G01N 2021/0339; G01N 2021/258

(57) ABSTRACT

A sample holder for use in an optical microscope is disclosed. The sample holder includes a plasmonic layer defining a periodic array of sub-micron structures wherein the periodic array of sub-micron structures comprise an array of separated plasmonic regions. The regions may be a circle, a torus, an ellipse, a cross, rectangle, square, line, strip. Methods of performing reflection and fluorescence microscopy using such a sample holder and other sample holders are also disclosed.

### CROSS-REFERENCE TO RELATED APPLICATIONS

This application is a continuation of U.S. patent application Ser. No. 17/297,974, filed May 27, 2021, which is the U.S. National Phase Application of International PCT Application No. PCT/IB2019/060305, filed on Nov. 29, 2019, which claims priority to Australian Patent Application No. 2018904553, filed Nov. 29, 2018. The entirety contents of each of the above-identified applications are hereby incorporated by reference herein and made part of this specification for all that they disclose.

### FIELD OF THE DISCLOSURE

The present disclosure relates to the field of optical microscopy. In one form the disclosure provides systems and methods of using an optical microscope and an enhanced sample holder.

### BACKGROUND OF THE DISCLOSURE

PCT/AU2018/050496 in the name of La Trobe University (the entire contents of which are herein incorporated by reference) discloses systems and methods of optical microscopy which provide enhanced image contrast through use of a sample holder having a plasmonic layer including a periodic array of sub-micron structures. In the present disclosure reference to a nanoslide is reference to a sample holder in accordance with the teaching of PCT/AU2018/050496, or the Applicant's co-pending Australian patent application 2018904553, filed on 29 Nov. 2018, entitled “Microscopy method and system” and the International patent application PCT/IB2019/060305 that claims priority to AU 2018904553, and which was filed on Nov. 29, 2019, the contents of both being incorporated herein by reference for all purposes. Microscopy methods using such a sample holder are called or histoplasmonics or colour contrast microscopy herein, which is abbreviated to CCM. The sample is placed on the sample holder adjacent the plasmonic layer. In use, the sample and sample holder are illuminated and an image of the sample is created. The inventors have observed that through interaction of the light with the sample and the plasmonic layer, a colour contrast is exhibited in the observed image. In particular, areas of the sample having different dielectric constant appear in the image with different colours. An increase in the intensity contrast is also achieved. In contrast to CCM, images obtained from conventional optical microscopy using a non-specific stain typically only exhibit an intensity contrast in a single colour, which corresponds to the stain used. Even when a counter-stain or biomarker is used, these conventional techniques only provide images in distinct colours.

### SUMMARY OF THE DISCLOSURE

As will be known to those skilled in the art, reflected light microscopy, in broad concept, is a microscopy technique that uses light reflected from the sample to form an image of the sample. Whilst the exemplary embodiments of the nanoslide disclosed in PCT/AU2018/050496 can be used in reflection microscopy without modification, the inventors have determined that such sample holders can be enhanced to improve its use in reflected light microscopy. In the present specification “forming an image” includes forming a human perceptible image, e.g. by focusing light so that a user can perceive an image of the sample (or part thereof); or generating a digital or photographic image of the sample (or part thereof) for storage, transmission, display or other downstream process.

Accordingly, a first aspect the present invention provides a sample holder for use in an optical microscope, the sample holder including: a plasmonic layer defining a periodic array of sub-micron structures; and wherein the sample holder is configured to support an object such that the periodic array of sub-micron structures is adjacent the object when supporting the object; wherein the periodic array of sub-micron structures comprise an array of separated plasmonic regions.

Accordingly, a second aspect of the present invention provides a sample holder for use in an optical microscope, the sample holder including: a plasmonic layer extending over a region of the sample holder, the plasmonic layer defining a periodic array of sub-micron structures; and wherein the sample holder is configured to support an object such that the periodic array of sub-micron structures is adjacent the object when supporting the object; wherein within the region the periodic array of sub-micron structures cause the plasmonic layer to fill, by area, not more than 80% of said region.

In some forms of the second aspect the periodic array of sub-micron structures cause the plasmonic layer to fill, by area, not more than one of 75%, 70%, 65%, 60%, 55%, 50%, 45%, 40%, 35%, 30%, 25%, 20%, 15%, 10%, 5% of the region. The region can cover an entire side of the sample holder.

In some embodiments of either the first or second aspects of the invention, the plasmonic regions can be islands of plasmonic material. In other embodiments the plasmonic regions can be lines or strips of plasmonic material separated from a neighbouring line(s) or stripe(s) by a non-plasmonic strip or line to form a one dimensional array of separated plasmonic regions.

In some embodiments of either the first or second aspects of the invention, sub-micron structures may be arranged in a periodic array with a separation between the sub-micron structures in the range of 200 nm to 500 nm. The sub-micron structures may have a largest dimension in the range of 50 nm to 300 nm. Most preferably the sub-micron structures are regions of plasmonic material about between 100 nm and 200 nm across. The plasmonic regions can be shaped as any one or more of: a circle, a torus, an ellipse, a cross, rectangle, square.

In some embodiments of either the first or second aspects of the invention, the plasmonic layer may be formed from one or more metals selected from any one of: Al, Ag, Au, Ni, Pt and Pd. The plasmonic layer may have a thickness in the range of 20 nm to 300 nm.

In some embodiments of either the first or second aspects of the invention, the array of separated plasmonic regions may be regular array with equal spacing between neighbouring plasmonic regions in a first and a second direction. Preferably the first and the second directions are orthogonal directions. However, the array may have different spacing in the first and second directions.

In some embodiments of either the first or second aspects of the invention, the sample holder includes a substrate connected to at least a portion of a first surface of the plasmonic layer to provide mechanical support for the plasmonic layer. In some embodiments, the sample holder includes an optically clear protective layer bonded to an upper side of the plasmonic layer to isolate the plasmonic layer. The optically clear protective layer may have a thickness less than 150 nm. In some embodiments the optically clear protective layer may have a thickness less than 80 nm. The optically clear protective layer may include any one or more of: silicon oxide, silicon nitride, transparent metal oxide, and a polymer. The sample holder can comprise a microscope slide.

In some embodiments of either the first or second aspects of the invention, the sample holder enables light, which is transmitted through the sample to the plasmonic layer to be reflected from the sample holder for the creation of images comprising the reflected light.

In some embodiments of either the first or second aspects of the invention, in use incident light illuminates the sample and sample holder and interacts with the sample and the plasmonic layer. The reflected light includes a characteristic spectra in which each colour is dependent on the localised dielectric constant of the sample. In this way, a colour image encoding localised dielectric constants of the sample can be formed from the reflected light.

The present inventors have further realised that a nanoslide, as described herein or in PCT/AU2018/050496 can also advantageously be used for fluorescence microscopy. Most advantageously, this can be performed in a microscopy arrangement adapted for reflected light microscopy.

Accordingly, the present invention also provides a method of imaging a sample comprising:
Providing a sample holder having an upper surface face and a lower surface, the upper surface having a plasmonic layer associated therewith, the plasmonic layer including a periodic array of sub-micron structures;
Applying the sample to the upper surface of the sample holder;
Illuminating the sample with light so that said light interacts with the sample and sample holder;
Receiving light emitted from the sample by fluorescence and forming an image thereof.

The method can further include receiving light after interaction with said sample and sample holder and forming at least one image thereof, wherein at least one localised structural property of the sample is visible in the image based on the colour of the received light. Such imaging is described in PCT/AU2018/050496 in greater detail. Herein an image so formed in this manner is termed a colour contrast image. Advantageously, in this way a sample mounted on the sample holder can be imaged using fluorescence microscopy in addition to using colour contrast imaging.

The image formed from the light emitted from the sample by fluorescence can be formed in a first time period, and the colour contrast image can be formed in a second time period. In some embodiments, illuminating the sample with light so that said light interacts with the sample and sample holder can include using a first illumination spectrum in the first time period, and a second illumination spectrum in the second time period. The first illumination spectrum can be selected on the basis of a fluorescence property of the sample. In some cases the first and second illumination spectra may be the same.

In some embodiments receiving light emitted from the sample by fluorescence includes filtering (e.g. based on wavelength or spatially filtering) light received from the sample and/or sample holder to minimise received light from sources other than said fluorescence.

In a preferred form, the method includes illuminating the sample from the side of the sample holder on which the sample is positioned, and receiving light emitted from the sample by fluorescence, and also light which has after interacted with said sample and sample holder, from the same side as said illumination.

It should be noted that the term upper surface and lower surface are not intended to reference a specific orientation of the sample holder either during sample preparation or use.

In embodiments of the present invention the method can include spatially correlating an image formed from the light emitted from the sample by fluorescence, and a colour contrast image. The method can include forming a combined image including an image formed from the light emitted from the sample by fluorescence, and a colour contrast image. Multiple images formed from the light emitted from the sample by fluorescence and/or multiple colour contrast images may be combined into a single image. The combination may be performed optically (e.g. during optical image formation) or digitally (e.g. by combining data values representing said images).

The sample is preferably a biological sample.

The sample holder used in embodiments of the present aspect of the invention can be a sample holder according to an embodiment of PCT/AU2018/050496, but most preferably is a sample holder in accordance with an embodiment of the first aspect of the present invention.

Images formed in the manners set out above may be used in histology and pathology in ways that may be apparent to those skilled in the art.

In a further aspect there is provided a system for forming an image using an embodiment of any one of the aspects set out above. The system can include a reflected light microscope having an image forming system, and an illumination system, and sample holder having an upper surface and a lower surface, the upper surface having a plasmonic layer associated therewith, the plasmonic layer including a periodic array of sub-micron structures. The system can include an image capture system to generate at least one image of the sample.

Embodiments of the present invention can be used to generate digital images subject to automated or partially automated methods of identifying a structure as taught in Applicant's co-pending Australian patent application 2018904551, filed on 29 November 2018, entitled “Automated method of identifying a structure” and the International patent application PCT/IB2019/060310 that claims priority to AU2018904551 and which was filed on the same day as PCT/IB2019/060305 (Nov. 29, 2019), the contents of both being incorporated herein by reference for all purposes.

Embodiments of an aspect of the present disclosure can be used in embodiments of the teaching of the applicant's co-pending Australian patent application 2018904550, filed on 29 Nov. 2018, entitled “Method of identifying a structure” and the International patent application PCT/IB2019/060309 that claims priority to AU 2018904550 which was filed on the same day as PCT/IB2019/060305 (Nov. 29, 2019), and is incorporated herein for all purposes.

### BRIEF DESCRIPTION OF THE DRAWINGS

Illustrative embodiments of the present invention will be described by way of non-limiting example with reference to the accompanying drawings. The drawings filed with the present international application include colour images used in, and arising from use of embodiments of the present invention. The colour information forms part of the disclosure of the embodiments. Should black and white or greyscale reproduction of the images occur, colour disclosure can be obtained from the originally filed documents. In the drawings:

FIG. 1a illustrates details of an exemplary sample holder used in embodiments of the present disclosure.

FIGS. 1b and 1c illustrate examples in which the plasmonic layer includes an array of sub-micron apertures.

FIGS. 1d to 1j illustrate examples were the sub-micron structures in the plasmonic layer are separated plasmonic regions. The present invention should not be considered to be limited to use of sample holders with the particular microstructure arrays illustrated FIGS. 1b to 1j.

FIG. 2a illustrates an example sample holder from FIG. 1a on which is positioned a sample for use in embodiments of the present invention.

FIG. 3A is a schematic diagram of a system used to perform reflected light microscopy.

FIG. 3B is a schematic diagram of a system illustrating how the embodiment of FIG. 3A can be used to perform fluorescence microscopy.

FIG. 3C illustrates schematically one example system in which fluorescence and colour contrast microscopy can be performed together.

FIG. 3D illustrates schematically another example system in which fluorescence and colour contrast microscopy can be performed together.

FIG. 4 illustrates an image captured using CCM (using a nanoslide) in reflection mode.

FIG. 5a illustrates exemplary light reception spectra when a nanoslide is used in reflection mode, for the case of no sample (air), a sample consisting of water, a sample consisting of a material with a refractive index of 1.5 (e.g. a polymer).

FIG. 5b illustrates the simulated appearance of the samples of FIG. 5, showing that colour contrast is exhibited between samples with differing structural properties in reflection mode microscopy.

### DETAILED DESCRIPTION OF THE EMBODIMENTS

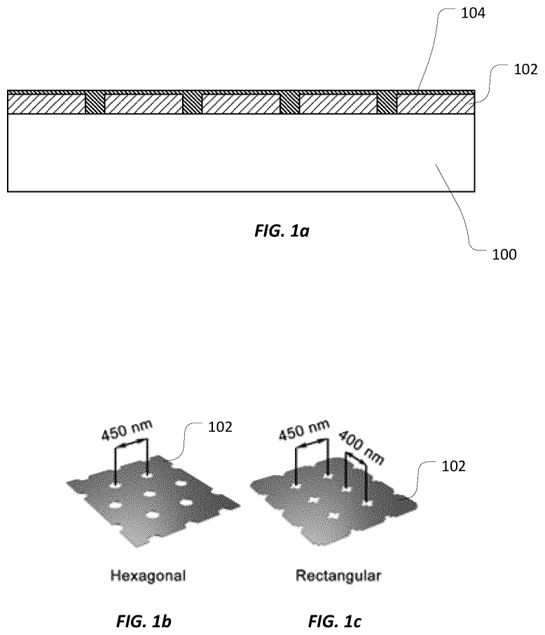

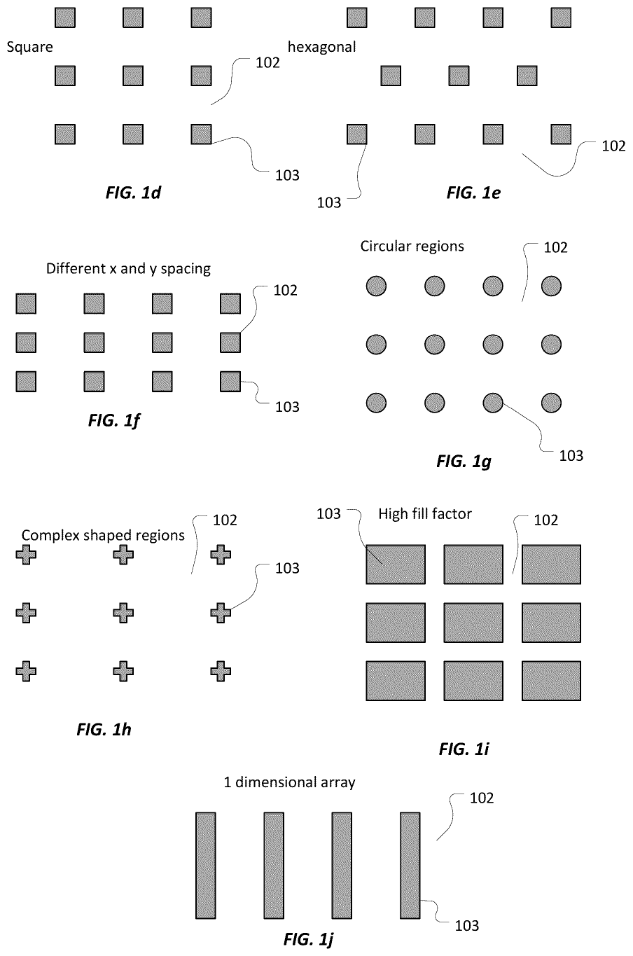

FIG. 1a shows an embodiment of a sample holder used in an example of the present disclosure. FIG. 1a shows a cross section through a sample holder suitable for use in the present invention. The sample holder 100 includes a substrate, on which is deposited a plasmonic layer 102. FIGS. 1b and 1c show two types of plasmonic layer as exemplified in PCT/AU2018/050496 with sub-micron arrays that have been fabricated and may be used in an embodiment. The layers are each silver films with a thickness of 150 nm, although other suitable materials can be used. FIG. 1b has sub-micron arrays in the form of circular shaped nanoapertures with a 450 nm period arranged in a hexagonal pattern. FIG. 1c has cross-shaped nanoapertures on a rectangular pattern. The cross-shaped nanoapertures have a 450 nm period in one direction (defined here as the 0° direction) and a 400 nm period in the orthogonal direction (defined as the 90° direction). These arrays have a Surface Plasmon Polariton (SPP) resonance mode in the 470-550 nm range (which is within the visible region of the electromagnetic spectrum). To protect the surface of the plasmonic layer 102, a layer 104 (10 nm±1 nm) of hydrogen silsesquioxane (HSQ), a glass-like material, is deposited after fabrication of the plasmonic layer 102. After capping with HSQ, the sample holder 100 has an upper surface similar to that of a conventional microscope slide on which a sample may be supported. In use, the HSQ layer also presents a polar surface which aids tissue adherence. In other embodiments a metal oxide capping layer e.g. SiO₂ can be used in place of HSQ.

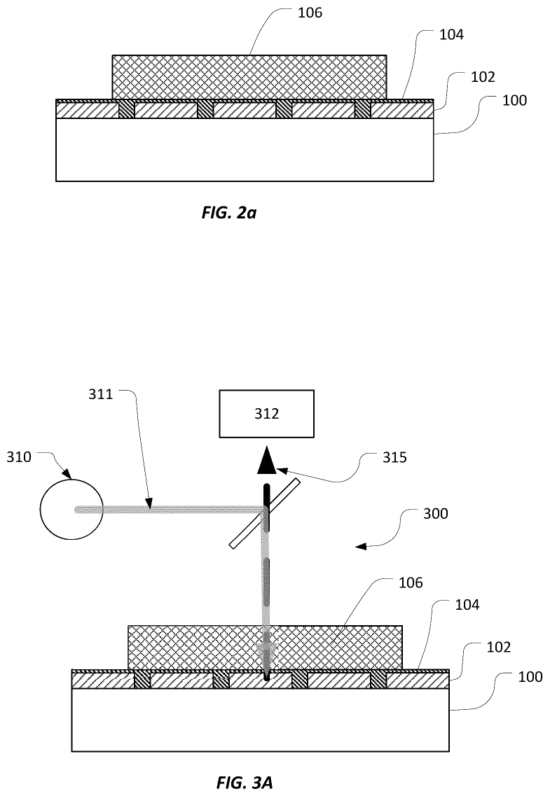

Samples to be imaged are prepared and placed on sample holders in accordance with an embodiment of PCT/AU2018/050496 in the name of La Trobe University or the Applicant's co-pending Australian patent application 2018904553, filed on 29 November 2018, entitled “Microscopy method and system” and the International patent application PCT/IB2019/060305 that claims priority to AU2018904553 and which was filed on Nov. 29, 2019. A sample 106, typically a slice of a biological tissue, which need not be stained or labelled in the preferred embodiment of the present invention, is placed on the sample holder adjacent the plasmonic layer, as shown in FIG. 2a.

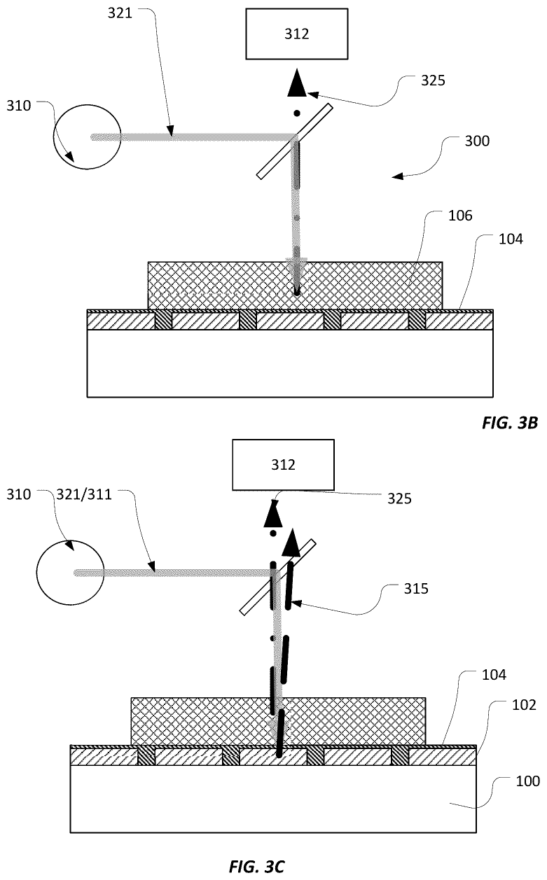

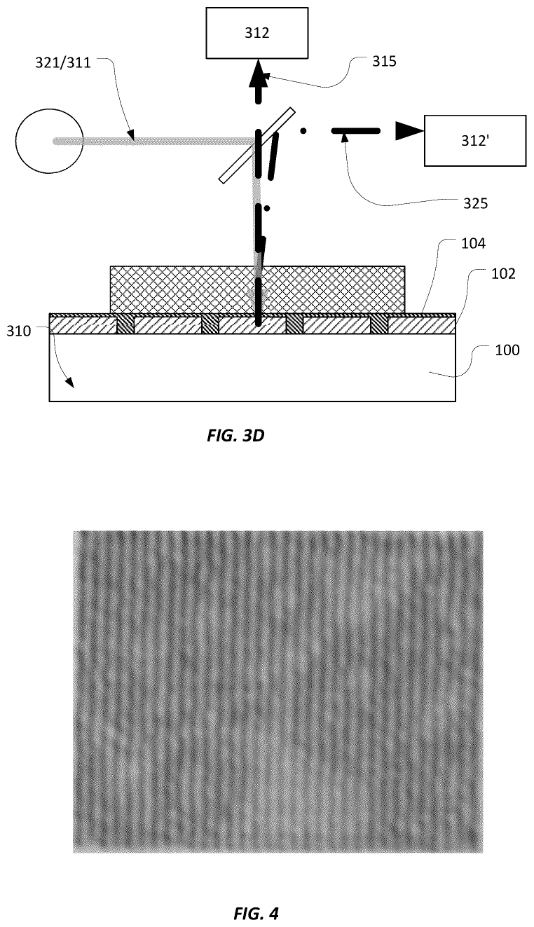

FIG. 3A is a schematic representation of a system 300 in which the sample holder 100 is used in reflected light microscopy. Techniques and equipment used in reflected light microscopy with conventional slides are known to those skilled in the art and in order to avoid obscuring the details of the present invention, the descriptions of known techniques will be omitted.

The system 300 includes a light source 310 which emits incident light 311 to illuminate the sample 106. The illumination is performed in this example from the side of the sample holder on which the sample is positioned. Reflected light 315 is reflected back to an imaging system 312 for creation of a colour contrast image. The sample holder 100 is a nanoslide having a plasmonic layer.

When system 300 is used in reflected light microscopy, the reflected light which forms the image has interacted with the plasmonic layer of the sample holder and the sample such that it possesses a reflection spectrum, which varies according to the local dielectric constant of the sample. Thus the reflected light image displays colour contrast.

FIG. 4 illustrates a reflection image of a thin section (70 nm) of the optical nerve of a mouse. Tissue was prepared in a convention manner and embedded in epoxy resin. 70 nm thick sections were cut on a Leica UC7 ultramicrotome. The image was captured using a 20× magnification and taken in reflection mode. In the image visible stripes arise from the fact that the submicron structures in the plasmonic layer of the nanoslide include structure with a periodicity of ˜450 nm, which lies in the visible region of the Em spectrum and therefore producing visible fringes in the image. Using smaller periodicities or different shaped arrays (e,g, hexagonal) can avoid such artefacts.

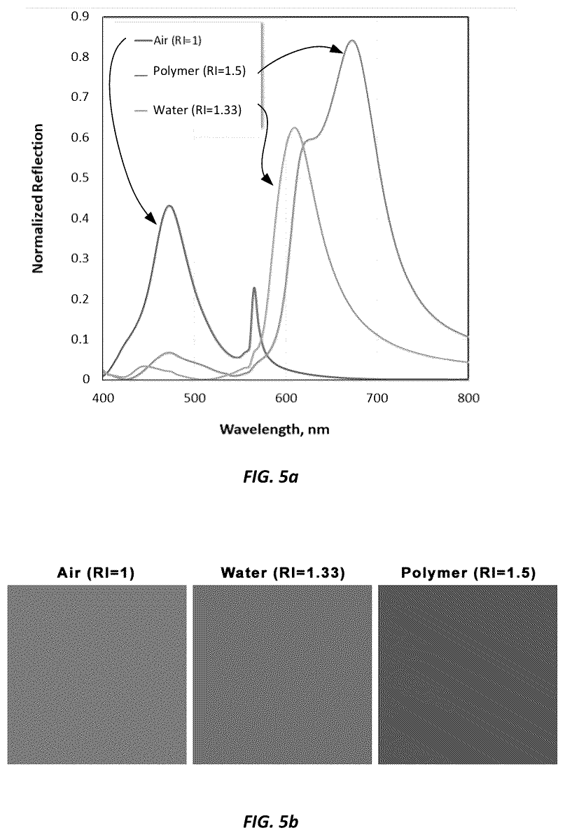

The specific reflection spectrum will be somewhat similar to the inverse of the normalised transmission spectra (e.g. as illustrated in PCT/AU2018/050496) with troughs appearing at the peaks in the transmission spectra. However there may be different sets of plasmon resonance modes present. FIG. 5 illustrates exemplary simulated light reception spectra when a nanoslide is used in reflection mode, for three sample cases as follows:
a sample with R=1 i.e. no sample, or the sample is air
a sample with R=1.33 (e.g. a sample consisting of water)
a sample with R=1.5 (e.g. a material, such as a polymer)

The simulated spectra are based on a nanoslide having circular islands of plasmonic material of radius 90 nm arranged in an array having a separation of 480 nm in a first direction in a hexagonal lattice array.

Compared to the illustrative examples of PCT/AU2018/050496, in which the plasmonic layer covers an entire region of the nanoslide with only small voids in it provided by the sub-micron structures, it has been found that when used in reflection microscopy it can be advantageous to provide a plasmonic layer region that because of the arrangement of a its sub-micron structures fills less (by area) of the region covered by the plasmonic layer. In some cases the plasmonic layer region can be filled (by area) by not more than one of 75%, 70%, 65%, 60%, 55%, 50%, 45%, 40%, 35%, 30%, 25%, 20%, 15%, 10%, 5% of the region. The reduction in fill factor can be advantageous in reflection microscopy because it reduces reflection of incident light (i.e. allows more transmission), such that the spectral peaks in the reflected light are more easily discernible from the troughs, which enhances the colour contrast effect in the received image.

FIG. 5b illustrate a simulated image of such samples showing the resultant visible colours from such samples. As can be seen:
the RI=1 sample (left) appears blue, corresponding to the position of the peak in its reflection spectrum;
the RI=1.33 sample (middle) appears orange, corresponding to the position of the peak in its reflection spectrum; and
the RI=1.5 sample (right) appears red, corresponding to the position of the peak in its reflection spectrum;
demonstrating that images formed using a nanoslide in reflection microscopy display colour contrast based on the dielectric constant of the sample which is related to the refractive index of the sample.

Importantly use of the nanoslide enables such colour contrast to be obtained without staining the sample, and when using substantially transparent samples. Accordingly the reflected light received includes light reflected from the plasmonic layer, as opposed to the upper surface of the sample. It also means that absorption within the sample itself is relatively low.

The microscope used conventional optical microscope with eyepieces for viewing by a user, however it can alternatively or additionally include an image capture system to generate a digital image for display, storage or other later use. In some forms the microscope can form part of an automated slide scanner. The system 300 can include a user terminal for display of captured digital images of the sample, and a data storage system for storing captured images.

When performing reflected light microscopy using a nanoslide, the present inventors have determined that the plasmonic layer can be specialised to yield improved results in some cases. In particular the periodic array of sub-micron structures can comprise an array of separated plasmonic regions. The plasmonic regions can be islands of plasmonic material separated by gaps. The plasmonic regions will typically be arranged in a periodic array with a separation between the sub-micron structures in the range of 200 nm to 500 nm. Each plasmonic region may have a largest dimension in the range of 50 nm to 300 nm. Most preferably the sub-micron structures are regions of plasmonic material between about 100 nm and 200 nm across. The plasmonic regions can be shaped as any one or more of: a circle, a torus, an ellipse, a cross, rectangle, square.

As set out in PCT/AU2018/050496, a plasmonic layer may be formed from one or more metals such as: Al, Ag, Au, Ni, Pt or Pd. The plasmonic layer may have a thickness in the range of 20 nm to 300 nm.

FIGS. 1d to 1j illustrate examples of such periodic arrays of sub-micron structures which comprise arrays of separated plasmonic regions.

FIG. 1d illustrates a plasmonic layer 102 including a regular rectangular array of square plasmonic regions 103. The spacing of the plasmonic regions 103 in the first and second directions are equal.

FIG. 1e illustrates a plasmonic layer 102 including an array of square plasmonic regions 103 arranged with equal spacing of the plasmonic regions 103 in the first and second directions, but with each row offset from its neighbour to form a hexagonal array of plasmonic regions 103. The separation between regions in the first and second (x and y) directions may be the same (as illustrated) or different.

FIG. 1f illustrates a plasmonic layer 102 including an array of square plasmonic regions 103 in which the spacing of the plasmonic regions 103 in the first and second directions are unequal. As set out in PCT/AU2018/050496 such an example can enable the use of polarised illumination to vary the spectrum of the received light by switching the relative polarisation of the received light with respect to the rows and columns of the array.

FIG. 1g illustrates an example plasmonic layer 102 including circular plasmonic regions 103. In this example the spacing of the plasmonic regions 103 in the first and second directions are equal, but other array arrangements could be used.

FIG. 1h illustrates an example plasmonic layer 102 including cross shaped plasmonic regions 103. In this example the spacing of the plasmonic regions 103 in the first and second directions are unequal equal, but other array arrangements could be used.

FIG. 1i illustrates an example plasmonic layer 102 including rectangular shaped plasmonic regions 103. However unlike the other embodiments the spacing between neighbouring plasmonic regions is relatively narrow. This yields a plasmonic layer in which the plasmonic regions occupy a fraction of the plasmonic layer greater than 50% by area.

FIG. 1j illustrates an example plasmonic layer 102 including plasmonic regions 103 shaped as strips separated by non-plasmonic strips, creating a 1-dimensional array of separated plasmonic regions.

As can be seen the array of plasmonic regions may be regular array with equal spacing between neighbouring plasmonic regions in a first and/or a second direction. Preferably the first and a second directions are orthogonal directions. However the array may have different spacing in the first and second directions.

The present invention also provides a method of fluorescence microscopy including:
Providing a sample holder having an upper surface face and a lower surface, the upper surface having a plasmonic layer associated therewith, the plasmonic layer including a periodic array of sub-micron structures;
Applying the sample to the upper surface of the sample holder;
Illuminating the sample with light so that said light interacts with the sample and sample holder;
Receiving light emitted from the sample by fluorescence and forming an image thereof.

The method can further include receiving light after interaction with said sample and sample holder and forming at least one image thereof, wherein at least one localised structural property of the sample is visible in the image based on the colour of the received light. Such imaging is described in PCT/AU2018/050496 in greater detail. Herein an image formed in this manner termed a colour contrast image. Advantageously, in this way a sample mounted on the sample holder can be imaged using fluorescence microscopy in addition to using colour contrast imaging.

As will be appreciated by those skilled in the art, fluorescence microscopy is typically performed with a reflected light microscopy arrangement, as it is necessary (or desirable) to illuminate the sample from the same side on which fluorescence induced in the sample is to be imaged. Accordingly the schematic arrangement of FIG. 3A can be also used for fluorescence imaging of the same sample as illustrated in FIG. 3B. In this example the light source 310 emits incident light 321 to illuminate the sample 106. The illumination causes the sample 106 to fluoresce. Light 325 emitted from the sample by fluorescence is captured by an imaging system 312 that enable creation of a fluorescence image of the sample.

As will be known to those skilled in the art fluorescence microscopy may require specialised sample preparation and labelling techniques. Wavelength selective illumination and image capture techniques may also be used. Details of general fluorescent sample preparation, illumination techniques or image capture techniques used in fluorescence microscopy images will not be described here in order not to obscure the details of the present invention.

In some embodiments fluorescence and colour contrast microscopy can be performed on the same sample serially or at the same time. In the case that they are performed serially, the image formed from the light emitted from the sample by fluorescence can be formed in a first time period, and the colour contrast image can be formed in a second time period.

It may be necessary or advantageous to use specific illumination properties in each type of microscopy, in this case the light used in the colour contrast imaging can have a different illumination spectrum than that used in fluorescence imaging. This may require using two light sources interchangeably or a common light source which is filtered differently in each time period. However in some cases the same spectra may be used.

FIG. 3C illustrates schematically an example where fluorescence imaging and colour contrast imaging of the same sample is performed using the system of FIGS. 3A and 3B. In this example the light source 310 emit light 321/311 (which may have the same spectrum or different spectra) to illuminate the sample 106. The illumination causes the sample 106 to fluoresce and also interacts with the sample and the plasmonic layer 102 of the sample holder 100. Received light 325 is emitted from the sample by fluorescence and received light 315 is reflected by the sample holder 100. Received light 315/325 is captured by an imaging system 312 to enable creation of both a fluorescence image and a colour contrast image of the sample. As noted above the emission of light 311 and 321 may be simultaneous or not.

FIG. 3D illustrates schematically an example where fluorescence imaging and colour contrast imaging of the same sample is performed using the system of FIGS. 3A and 3B. In this example the light source 310 emit light 321/311 (which may have the same spectrum or different spectra) to illuminate the sample 106. The illumination causes the sample 106 to fluoresce and also interacts with the sample and the plasmonic layer 102 of the sample holder 100. Received light 325 is emitted from the sample by fluorescence and received light 315 is reflected by the sample holder 100. Received light 315 is captured by a first imaging system 312 to enable creation of a colour contrast reflection image. Received light 325 is captured by a second imaging system 312′ to enable creation of a fluorescence image of the same sample. As noted above the emission of light 311 and 321 may be simultaneous or not. For FIGS. 3C and 3D, in some instances a sample may fluoresce during colour contrast microscopy when it is not desired. This can generally be dealt with by filtering out the fluorescent wavelength(s) at image formation or by not illuminating the sample in a wavelength bend that causes fluorescence. Fluorescence occurs at very specific wavelengths as it is generated via specific optical transitions within a fluorescent tag, and therefore the fluorescence appears as a line (or lines) in a received spectrum. These characteristic line(s) can be isolated from the smoother continuous background spectrum of the colour contrast image. In the event that a fluorescence line happens to coincide with a strong wavelength peak in the received colour spectrum in the colour contrast image this can be corrected by using a nanoslide with a different separation sub-micron structures or in the event that the nanoslide being used has a different separation between sub-micron structures in different directions, changing the polarisation of the illumination of the colour contrast image. As set out in the Applicant's co-pending Australian patent applications, filed on the same day as the priority application to the present application and entitled “Automated method of identifying a structure” and “Method of identifying a structure”, this will alter the received light spectrum in the colour contrast image but not the fluorescence image.

Images captured by the present methods can be used individually or together to draw conclusions about the sample. In some embodiments of the present invention the method can include spatially correlating an image formed from the light emitted from the sample by fluorescence, and a colour contrast image.

This can be performed by generating a combined image showing both colour contrast information and fluorescence images. Multiple images formed from the light emitted from the sample by fluorescence (e.g. one for each fluorescence wavelength) and/or multiple colour contrast images (captured at different polarisations) may be combined into a single image.

The combination may be performed optically (e.g. during optical image formation) or digitally (e.g. by combining data values representing said images). It will be understood that the invention disclosed and defined in this specification extends to all alternative combinations of two or more of the individual features mentioned or evident from the text or drawings. All of these different combinations constitute various alternative aspects of the invention.

1-34. (canceled)

35. A method of imaging a sample located on an upper surface of a sample holder, comprising:
illuminating the sample and the sample holder with first incident light having a first illumination spectrum directed towards the upper surface of the sample holder, wherein the sample holder comprises: a substrate; and a plasmonic layer comprising a periodic array of sub-micron structures comprising an array of separated plasmonic regions supported by the substrate such that the plasmonic layer is located between the substrate and the sample; and
receiving first return light corresponding to a reflection of the first incident light by the sample holder, wherein the first return light corresponds to the first incident light modified due to an interaction between the first incident light and the plasmonic layer of the sample holder, wherein the first return light comprises a reflection spectrum having a spatial variation in color dependent upon localized variations in dielectric constant of the sample and the plasmonic layer.

36. The method of claim 35, wherein the sample is a slide of biological tissue.

37. The method of claim 36, wherein the biological tissue is not stained and/or labelled before illumination with the first incident light; and/or wherein the biological tissue is substantially transparent.

38. The method of claim 35, further comprising:
capturing a digital image of the first return light.

39. The method of claim 35, wherein:
the sub-micron structures are arranged in a periodic array with a separation between the sub-micron structures in at least a first direction in the range of 200 nm to 500 nm;
and/or the sub-micron structures have a largest dimension in the range of 50 nm to 300 nm; and/or
wherein the plasmonic layer has a thickness in the range of 20 nm to 300 nm.

40. The method of claim 35, wherein the sub-micron structures are islands of plasmonic material separated by gaps.

41. The method of claim 35, wherein the sample holder includes an optically clear protective layer located on an opposite side of the plasmonic layer to the substrate to isolate the plasmonic layer.

42. The method of claim 35, further comprising:
applying the sample to the upper surface of the sample holder before illuminating the sample with the first incident light.

43. The method of claim 35, further comprising:
illuminating the sample with second incident light having a second illumination spectrum directed towards the upper surface of the sample holder, wherein the second illumination spectrum is selected to cause fluorescence by the sample; and
receiving second return light corresponding to fluorescence of the sample due to the second incident light.

44. The method of claim 43, further comprising:
forming a first image of the first return light; and
forming a second image of the second return light.

45. The method of claim 44, wherein the first image is formed in a first time period, and the second image is formed in a second time period, wherein the sample and sample holder are illuminated by the first incident light and not the second incident light during the first time period, and wherein the sample and sample holder are illuminated by the second incident light and not the first incident light during the second time period.

46. The method of claim 44, wherein the first image and the second image are formed simultaneously.

47. The method of claim 44, further comprising:
spatially correlating the first image and the second image with respect to the location of the sample; and
generating a combined digital image by combining the spatially correlated first image and second image.

48. The method of claim 47, wherein the first image and the second image are spatially correlated and combined optically.

49. The method of claim 43, wherein the first illumination spectrum and the second illumination spectrum are the same.

50. The method of claim 43, wherein the first illumination spectrum and the second illumination spectrum are the different.

51. A system for capturing an image of a sample, the system comprising:
a reflected light microscope including a sample holder mounting location;
an illumination system configured to illuminate the sample located on an upper surface of a sample holder with first incident light having a first illumination spectrum directed towards the upper surface of the sample holder, when the sample holder is located at the sample holder mounting location of the reflected light microscope, and wherein the sample holder comprises: a substrate; and a plasmonic layer comprising a periodic array of sub-micron structures comprising an array of separated plasmonic regions supported by the substrate such that the plasmonic layer is located between the substrate and the sample; and
an image capture system configured to capture a first image of received first return light corresponding to a reflection of the first incident light by the sample holder, wherein the first return light corresponds to the first incident light modified due to an interaction between the first incident light and the plasmonic layer of the sample holder, wherein the first return light comprises a reflection spectrum having a spatial variation in color dependent upon localized variations in dielectric constant of the sample and the plasmonic layer.

52. The system of claim 51, further comprising the sample holder.

53. The system of claim 51, wherein:
the illumination system is configured to illuminate the sample with second incident light having a second illumination spectrum directed towards the upper surface of the sample holder, wherein the second illumination spectrum is selected to cause fluorescence by the sample; and
the image capture system is configured to capture an image of the received second return light corresponding to fluorescence of the sample due to the second incident light.

54. The system of claim 53, wherein:
the illumination system is configured to: illuminate the sample with the first incident light and not the second light during a first time period, and illuminate the sample with the second incident light and not the first light during a second time period; and
the image capture system is configured to: capture the image of the received first return light during the first time period, and capture the image of the received second return light during the second time period.

55. The system of claim 53, wherein:
the illumination system is configured to: illuminate the sample with the first incident light and illuminate the sample with the second incident light simultaneously.
